(19) United States
(12) Patent Application Publication
(10) Pub. No.: US 2016/0296980 A1
(43) Pub. Date: Oct. 13, 2016

(54) PORTABLE VISUAL CLEANING DEVICE

(71) Applicant: Junming ZHENG, Guangdong (CN)

(72) Inventor: Junming ZHENG, Guangdong (CN)

(21) Appl. No.: 15/100,633

(22) PCT Filed: Sep. 1, 2014
(86) PCT No.: PCT/CN2014/085674

§ 371 Date: May 31, 2016

(30) Foreign Application Priority Data
Aug. 9, 2014 (CN) 201420447744.3

(51) Int. Cl. B08B 3/02; B60S 3/00; G02B 23/24; B05B 7/24; B08B 13/00; B65D 41/02

(52) U.S. Cl. CPC B08B 3/026; B08B 13/00; B65D 41/02; G02B 23/2484; B05B 7/2424; B60S 3/00

(57) ABSTRACT

A portable visual cleaning device having a gun, an air/liquid switching valve, an endoscope display, an endoscope probe, an endoscope wire, a flexible pipe, a liquid outlet pipe and a liquid storage bottle: an air inlet channel and an air transmission channel are provided in the gun; a liquid pumping port and a liquid outlet port in communication with the air transmission channel are arranged on one end of the gun; the liquid pumping port of the gun is connected to a bottle cap of the liquid storage bottle via the air/liquid switching valve; one end of the liquid outlet pipe is connected to the air transmission channel, and the other end of the liquid outlet pipe is provided with a nozzle; the flexible pipe is sheathed on the liquid outlet pipe and the endoscope wire.

### BACKGROUND OF THE INVENTION

The present invention relates to the field of cleaning equipment, and in particular to a portable visual cleaning device capable of being applied to automobile cleaning.

Along with economical development and progress of the automobile industry, family passenger vehicles and various commercial vehicles are popularized in a large scale. In order to improve operation performance of automobiles, automobile users pay attention to daily maintenance of automobiles.

As is well known, in the long-term automobile using process, plenty of dirt and bacteria are accumulated in the automobile. At present, there are several automobile cleaning methods as follows: 1. a foam cleaning agent is sprayed through a thin spray pipe into an automobile component or device needing cleaning, and this cleaning method usually leads to the problems that the cleaning effect is poor, the automobile component or device is not cleaned thoroughly and there are many sanitation blind corners; 2. various automobile components are dismantled and are cleaned one by one through an automobile cleaning machine, so that the components can be cleaned thoroughly; however, the method is high in technicality, workload and cost and low in efficiency, and the automobile cleaning machine is complex in structure, large in size and inconvenient to carry.

### BRIEF SUMMARY OF THE INVENTION

The object of the present invention is to overcome the aforementioned shortcomings in the prior art, and provide a portable visual cleaning device which is simple in structure, convenient to operate and carry and high in working efficiency, can clean thoroughly, is low in cost and can display the cleaning process in real time.

In order to achieve the aforementioned object, the technical solution provided by the present invention is as follows: a portable visual cleaning device, comprising a gun, an air/liquid switching valve, an endoscope display, an endoscope probe, a flexible pipe, a liquid outlet pipe and a liquid storage bottle with a bottle cap, wherein an air inlet channel and an air transmission channel are arranged in the gun; a trigger switch is hinged on the gun and the trigger switch is connected with a connecting rod valve body for making the air inlet channel and the air transmission channel opened or closed; the connecting rod valve body is mounted in the gun and located between the air inlet channel and the air transmission channel; the connecting rod valve body is sleeved with a reset spring; one end of the gun is provided with a liquid pumping port and a liquid outlet port, one end of the air transmission channel is in communication with the liquid pumping port and the liquid outlet port of the gun, and the liquid pumping port of the gun is connected with the bottle cap of the liquid storage bottle through the air/liquid switching valve; a liquid pumping pipe connected to the air/liquid switching valve is arranged in the liquid storage bottle; one end of the liquid outlet pipe is connected to the air transmission channel, and the other end of the liquid outlet pipe is provided with a nozzle; the endoscope display is mounted on the gun; the endoscope display is electrically connected with the endoscope probe through an endoscope wire; the flexible pipe is sheathed on the liquid outlet pipe and the endoscope wire, and one end of the flexible pipe is connected to the liquid outlet port of the gun.

Preferably, in the technical solution, the nozzle is set as a variable nozzle capable of switching a water spraying mode.

Preferably, in the technical solution, the endoscope display is electrically connected with an external power supply through a power line.

Preferably, in the technical solution, through a power line, the endoscope display is electrically connected with a storage battery mounted in the gun.

Preferably, in the technical solution, the gun is set as a metal gun or a hard plastic gun.

Compared with the prior art, the present invention has the beneficial effects that:

the gun is provided with the endoscope display, the liquid storage bottle for storing cleaning fluid and a visual cleaning pipe composed of the flexible pipe, the endoscope probe, the liquid outlet pipe and the nozzle. During cleaning, visual cleaning operation can be performed as long as the visual cleaning pipe is placed in an automobile component needing cleaning, and the automobile component does not need to be dismantled. The portable visual cleaning device is simple in structure, convenient to operate and carry and low in cost, enables users to learn about the position needing cleaning in real time and watch the cleaning process and cleaning effect, can clean thoroughly, is high in working efficiency, and can be suitable for cleaning an automobile air conditioner evaporation tank, a combustion chamber, an air inlet channel, an air inlet manifold, an air duct or other automobile components and devices as well as air-conditioning or central air-conditioning pipes and air ducts of civil buildings such as offices and homes.

### BRIEF DESCRIPTION OF THE DRAWINGS

FIG. 1 is an appearance structural schematic diagram of a portable visual cleaning device;

FIG. 2 is an internal schematic diagram of a local structure of a portable visual cleaning device;

FIG. 3 is an internal schematic diagram of a local structure of a portable visual cleaning device;

FIG. 4 is a local structural schematic diagram of a portable visual cleaning device;

FIG. 5 is a positional schematic diagram of a liquid outlet pipe and an endoscope wire in a flexible pipe; and

FIG. 6 is a connecting schematic diagram of a liquid pumping pipe of a portable visual cleaning device and an external liquid storage container.

The portable visual cleaning device according to the present invention is further described below in combination with drawings and embodiments.

### DETAILED DESCRIPTION OF THE INVENTION

The following is an optimal embodiment of a portable visual cleaning device according to the present invention, and does not accordingly limit the protective scope of the invention.

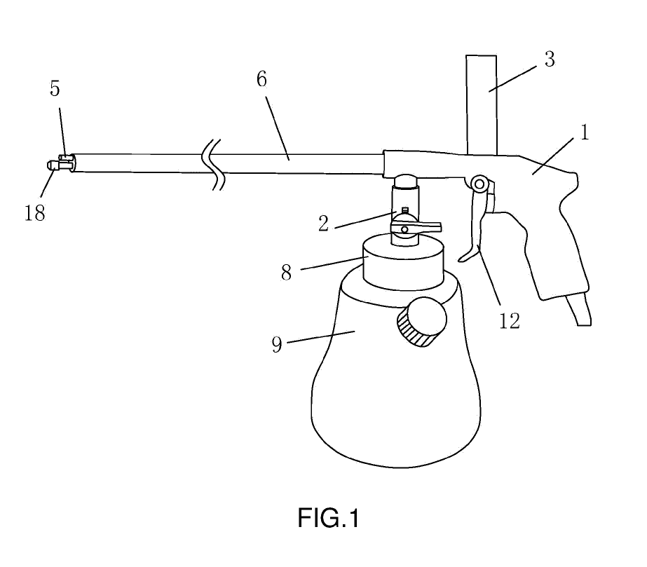

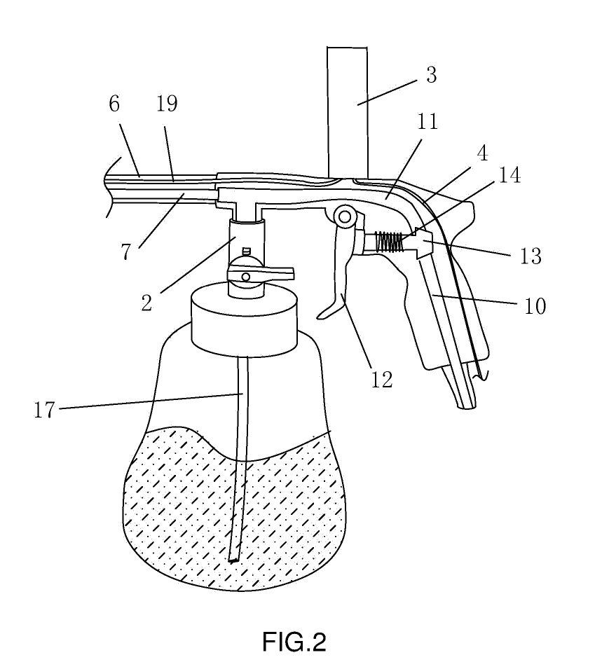

Referring to FIGS. 1 and 2, they illustrate a portable visual cleaning device which comprises a gun 1, an air/liquid switching valve 2, an endoscope display 3, an endoscope probe 5, a flexible pipe 6, a liquid outlet pipe 7, a nozzle 18, an endoscope wire 19 and a liquid storage bottle 9 with a bottle cap 8, and cleaning fluid is stored in the liquid storage bottle 9. The structure and connection relation and principle of each component of the portable visual cleaning device are described in detail below.

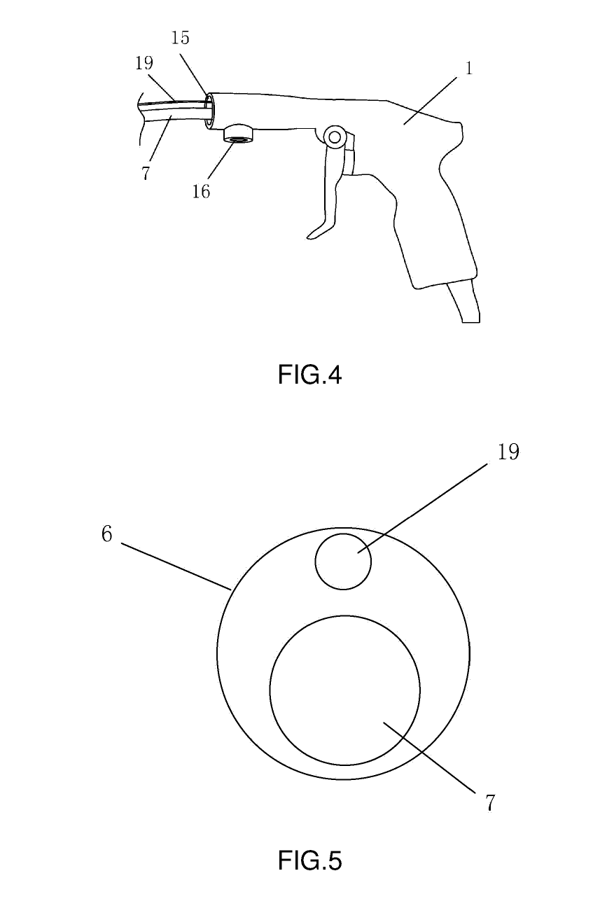

As shown in FIGS. 2, 4 and 5, an air inlet channel 10 and an air transmission channel 11 are arranged in the gun 1; a trigger switch 12 is hinged on the gun 1 and the trigger switch 12 is connected with a connecting rod valve body 13 for making the air inlet channel 10 and the air transmission channel 11 opened or closed; the connecting rod valve body 13 is mounted in the gun 1 and located between the air inlet channel 10 and the air transmission channel 11; the connecting rod valve body 13 is sleeved with a reset spring 14; one end of the gun 1 is provided with a liquid pumping port 15 and a liquid outlet port 16, one end of the air transmission channel 11 is in communication with the liquid pumping port 15 and the liquid outlet port 16 of the gun 1, and the liquid pumping port 15 of the gun 1 is connected with the bottle cap 8 of the liquid storage bottle 9 through the air/liquid switching valve 2; a liquid pumping pipe 17 connected to the air/liquid switching valve 2 is arranged in the liquid storage bottle 9; one end of the liquid outlet pipe 7 is connected to the air transmission channel 11 at the position of the liquid outlet port 16 of the gun 1, and the other end of the liquid outlet pipe 7 is provided with a nozzle 18; the endoscope display 3 is mounted on the gun 1; the endoscope display 3 is electrically connected with the endoscope probe 5 through an endoscope wire 19; the flexible pipe 6 is sheathed on the liquid outlet pipe 7 and the endoscope wire 19, and one end of the flexible pipe 6 is connected to the liquid outlet port 16 of the gun 1; and the endoscope probe 5 and the nozzle 18 extend to the outside of the other end of the flexible pipe 6. The flexible pipe 6, the endoscope probe 5, the liquid outlet pipe 7 and the nozzle 18 form a visual cleaning pipe.

As a preferred embodiment, the nozzle 18 is preferably set as a variable nozzle capable of switching a water spraying mode. The variable nozzle can change sprayed cleaning fluid into a mist shape, a water column shape, a sector shape or a scattered shape. According to the actual demand, users can freely select a water spraying mode to clean automobile components, and the practicality of the device is further improved.

In this embodiment, the gun 1 may be made of hard materials such as metal and rigid plastics, and the structural strength of the device can be improved.

As shown in FIG. 2, the endoscope display 3 may be electrically connected with an external power supply through a power line 4. The endoscope display 3 has functions of real-time display, video recording and camera shooting, and video signals generated through shooting by the endoscope probe 5 are sent through the endoscope wire 19 to the endoscope display 3 to be displayed.

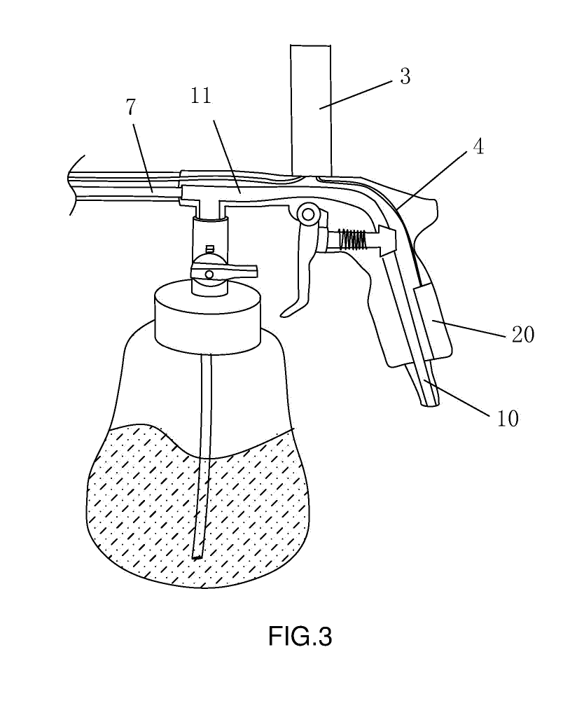

Of course, as can be seen from FIG. 3, through a power line 4, the endoscope display 3 may also be electrically connected with a storage battery 20 mounted in the gun 1.

The present invention has the cleaning operation process as follows:

1. cleaning fluid is added into the liquid storage bottle 9;

2. the power supply is on, and an upper air pipe of an air pressure supply device is connected with an inlet of the air inlet channel 10;

3. an automobile component needing cleaning is found, the endoscope display 3 is started, and the visual cleaning pipe of the cleaning device is inserted into the automobile component, so as to observe the pollution conditions;

4. the trigger switch 12 is turned on to make the connecting rod valve body 13 moved away, at the time the air inlet channel 10 and the air transmission channel 11 are in an open mode, and gas enters the liquid outlet pipe 7 through the air transmission channel 11 and then is sprayed out of the nozzle 18;

5. when the cleaning fluid needs outputting, the air/liquid switching valve 2 is switched on, at the time the liquid pumping pipe 17 is in a negative pressure state, so that the cleaning fluid is conveyed to the liquid outlet pipe 7 through the liquid pumping pipe 17, and finally the cleaning fluid is sprayed out of the nozzle 18;

6. after the automobile component is cleaned, the air/liquid switching valve 2 is switched off, and then residual fluid is blown dry through air.

In conclusion, according to the invention, visual cleaning operation can be performed, and the automobile component does not need to be dismantled. The portable visual cleaning device is simple in structure, convenient to operate and carry and low in cost, enables users to learn about the position needing cleaning in real time and watch the cleaning process and cleaning effect, can clean thoroughly, and is high in working efficiency. In practical application, the portable visual cleaning device can be suitable for cleaning an automobile air conditioner evaporation tank, a combustion chamber, an air inlet channel, an air inlet manifold, an air duct or other automobile components, devices or systems as well as air-conditioning or central air-conditioning pipes and air ducts of civil buildings (such as offices and homes).

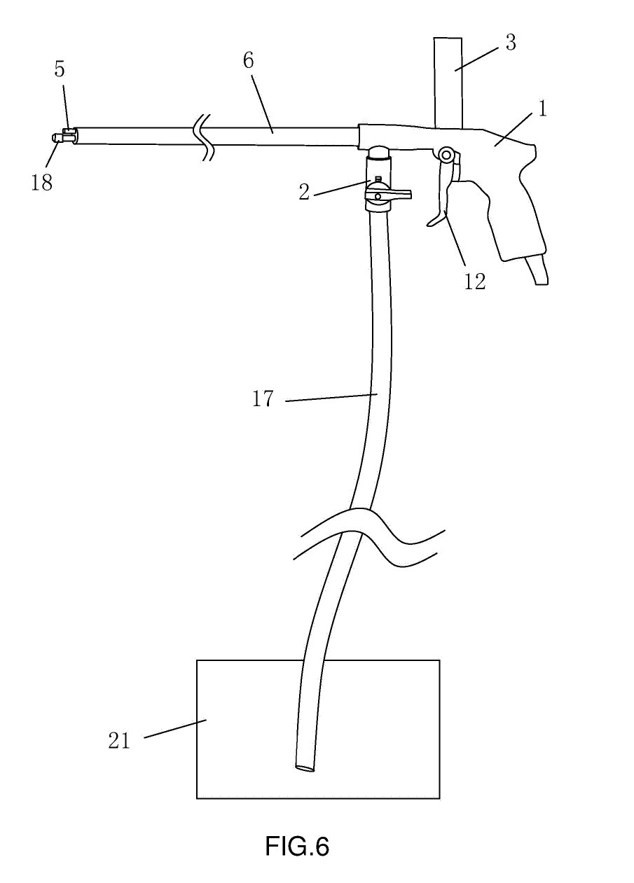

Moreover, as can be known from FIG. 6, according to the portable visual cleaning device, the liquid storage bottle 9 can also be dismantled, and during work, the liquid pumping pipe 17 can be directly inserted into an external liquid storage container 21 or other liquid storage devices and is in sealed connection with the external liquid storage container 21 or other liquid storage devices, so that the weight of the cleaning device can be alleviated, the portability of the cleaning device is improved effectively, and users can work high above the ground conveniently. It needs to be noted here that according to the difference of the operating environment, the length and thickness of the liquid pumping pipe 17 can be adjusted appropriately.

The aforementioned embodiments are preferred embodiments of the present invention, but the embodiments of the present invention are not subject to limitation to the aforementioned embodiments. Any other variation, modification, replacement, combination and simplification without departing from the spirit and principle of the present invention should be equivalent substitution modes and are included in the protection scope of the present invention.

What is claimed is:

1. A portable visual cleaning device, comprising a gun (1), an air/liquid switching valve (2), an endoscope display (3), an endoscope probe (5), a flexible pipe (6), a liquid outlet pipe (7) and a liquid storage bottle (9) with a bottle cap (8), wherein an air inlet channel (10) and an air transmission channel (11) are arranged in the gun (1); a trigger switch (12) is hinged on the gun (1) and the trigger switch (12) is connected with a connecting rod valve body (13) for making the air inlet channel (10) and the air transmission channel (11) opened or closed; the connecting rod valve body (13) is mounted in the gun (1) and located between the air inlet channel (10) and the air transmission channel (11); the connecting rod valve body (13) is sleeved with a reset spring (14); one end of the gun (1) is provided with a liquid pumping port (15) and a liquid outlet port (16), one end of the air transmission channel (11) is in communication with the liquid pumping port (15) and the liquid outlet port (16) of the gun (1), and the liquid pumping port (15) of the gun (1) is connected with the bottle cap (8) of the liquid storage bottle (9) through the air/liquid switching valve (2); a liquid pumping pipe (17) connected to the air/liquid switching valve (2) is arranged in the liquid storage bottle (9); one end of the liquid outlet pipe (7) is connected to the air transmission channel (11), and the other end of the liquid outlet pipe (7) is provided with a nozzle (18); the endoscope display (3) is mounted on the gun (1); the endoscope display (3) is electrically connected with the endoscope probe (5) through an endoscope wire (19); the flexible pipe (6) is sheathed on the liquid outlet pipe (7) and the endoscope wire (19), and one end of the flexible pipe (6) is connected to the liquid outlet port (16) of the gun (1).

2. The portable visual cleaning device according to claim 1, wherein the nozzle (18) is set as a variable nozzle capable of switching a water spraying mode.

3. The portable visual cleaning device according to claim 1, wherein the endoscope display (3) is electrically connected with an external power supply through a power line (4).

4. The portable visual cleaning device according to claim 1, wherein through a power line (4), the endoscope display (3) may also be electrically connected with a storage battery (20) mounted in the gun (1).

5. The portable visual cleaning device according to claim 1, wherein the gun (1) is set as a metal gun or a hard plastic gun.
